(19) United States
(12) Patent Application Publication
(10) Pub. No.: US 2026/0120508 A1
(43) Pub. Date: Apr. 30, 2026

(54) METHOD AND APPARATUS FOR THREAT DETECTION BASED ON FACIAL IMAGE ANALYSIS

(71) Applicant: Suprema Inc., Seongnam-si (KR)

(72) Inventors: Cheulhui JEONG, Seongnam-si (KR); Kyeonga KIM, Seongnam-si (KR); Bongseop SONG, Seongnam-si (KR); Hyeonchang LEE, Seongnam-si (KR)

(21) Appl. No.: 18/952,356

(22) Filed: Nov. 19, 2024

(30) Foreign Application Priority Data
Oct. 31, 2024 (KR) 10-2024-0152925

(51) Int. Cl. G06V 40/16; G06V 40/18

(52) U.S. Cl. CPC G06V 40/174; G06V 40/161; G06V 40/172; G06V 40/18

(57) ABSTRACT

There is provided a method for threat detection based on facial image analysis, the method comprises identifying a face from a facial image acquired from a camera, inferring an emotion corresponding to the face to obtain an emotion-based threat score based on the inferred emotion, obtaining an eye-based threat score based on a blink frequency of eyes on the face and a number of pupil movements in the face, and detecting whether a person corresponding to the face is in a threat situation based on a total threat score calculated by combining the emotion-based threat score and the eye-based threat score.

### CROSS-REFERENCE TO RELATED APPLICATION

This application claims priority to Korean Patent Application No. 10-2024-0152925, filed on Oct. 31, 2024, the entirety of which is incorporated herein by reference for all purposes.

### TECHNICAL FIELD

The present disclosure relates to a method and apparatus for threat detection based on facial image analysis.

This work was supported by Korea Internet & Security Agency grant funded by the Korea government (Ministry of Science and ICT) (Project No.: KISASupport-2024-28; R&D project: 2024 AI Security Product and Service Commercialization Support Project; Research Project Title: Commercialization of high-performance embedded modules based on cross-recognition technology between heterogeneous cameras; and Project period: 2024 Jun. 1˜2024 Nov. 30)

### BACKGROUND

Threat situations can occur in dark environments with little light, where it may be difficult for conventional RGB cameras to acquire clear images for threat detection determination.

Near-infrared (NIR) imaging typically uses near-infrared wavelengths ranging from 700 nm to 1000 nm. Since near-infrared wavelengths are outside the visible light range, near-infrared wavelengths cannot be perceived by the human eye, but NIR imaging can identify areas that are difficult or impossible to detect with visible light (RGB) cameras, so NIR imaging can be useful in low-light or nighttime environments.

Accordingly, there is a need for a technology that acquires facial information from NIR images and utilizes it to determine a threat situation when the threat situation occurs in a dark environment with little light as described above.

### SUMMARY

In view of the above, the present disclosure provides a method and apparatus for detecting a threat situation by analyzing a facial image acquired even in a dark environment with little light.

However, the problem to be solved by the present disclosure is not limited to that mentioned above, and other problems to be solved that are not mentioned may be clearly understood by those of ordinary skill in the art to which the present disclosure belongs from the following description.

In accordance with an aspect of the present disclosure, there is provided a method for threat detection based on facial image analysis, the method comprises identifying a face from a facial image acquired from a camera, inferring an emotion corresponding to the face to obtain an emotion-based threat score based on the inferred emotion, obtaining an eye-based threat score based on a blink frequency of eyes on the face and a number of pupil movements in the face, and detecting whether a person corresponding to the face is in a threat situation based on a total threat score calculated by combining the emotion-based threat score and the eye-based threat score.

The camera may be a near-infrared (NIR) camera, and the facial image is acquired from the near-infrared camera.

When the inferred emotion belongs to one of preset threat emotion classes, the emotion-based threat score may be determined dependent on a confidence level for the inferred emotion.

When the inferred emotion does not belong to any of preset threat emotion classes, the emotion-based threat score may be determined to be 0.

The eye-based threat score may be calculated by applying a first confidence level to the eye blink frequency and a second confidence level to the number of pupil movements.

The method may further comprise acquiring movement of the face, wherein the eye-based threat score may be calculated by identifying the movement of pupil in the face while taking the movement of the face into account.

The total threat score may be calculated by reflecting a result of applying a first weight to the emotion-based threat score and a result of applying a second weight to the eye-based threat score.

The first weight and the second weight may be determined based on confidence levels for the inferred emotion, the eye blink frequency, and the number of pupil movements.

In the detecting whether a person corresponding to the face is in a threat situation, it may be determined that the person is in the threat situation when the total threat score exceeds a threshold.

In accordance with another aspect of the present disclosure, there is provided an apparatus for threat detection based on facial image analysis comprising a memory storing computer-executable instructions, and a processor configured to execute the instructions to identify a face from a facial image acquired from a camera, infer an emotion corresponding to the face to obtain an emotion-based threat score based on the inferred emotion, obtain an eye-based threat score based on a blink frequency of eyes on the face and a number of pupil movements in the face and detect whether a person corresponding to the face is in a threat situation based on a total threat score calculated by combining the emotion-based threat score and the eye-based threat score.

The camera may be a near-infrared (NIR) camera, and the facial image is acquired from the near-infrared camera.

When the inferred emotion belongs to one of preset threat emotion classes, the emotion-based threat score may be determined dependent on a confidence level for the inferred emotion.

When the inferred emotion does not belong to any of preset threat emotion classes, the emotion-based threat score may be determined to be 0.

The eye-based threat score may be calculated by applying a first confidence level to the eye blink frequency and a second confidence level to the number of pupil movements.

The processor may acquire movement of the face, wherein the eye-based threat score may be calculated by identifying the movement of pupil in the face while taking the movement of the face into account.

The total threat score may be calculated by reflecting a result of applying a first weight to the emotion-based threat score and a result of applying a second weight to the eye-based threat score.

The first weight and the second weight may be determined based on confidence levels for the inferred emotion, the eye blink frequency, and the number of pupil movements.

The processor may determine that the person is in the threat situation when the total threat score exceeds a threshold.

In accordance with another aspect of the present disclosure, there is provided a non-transitory computer-readable storage medium storing a computer program, wherein the computer program, when executed by a processor, comprises an instruction for causing the processor to perform a method comprises identifying a face from a facial image acquired from a camera, inferring an emotion corresponding to the face to obtain an emotion-based threat score based on the inferred emotion, obtaining an eye-based threat score based on a blink frequency of eyes on the face and a number of pupil movements in the face and detecting whether a person corresponding to the face is in a threat situation based on a total threat score calculated by combining the emotion-based threat score and the eye-based threat score.

According to one embodiment of the present disclosure, it is possible to determine whether a person in the image is in a threat situation based on the emotion or eye movement of the person in the image.

Further, it is possible to accurately determine whether a person in the image is in a threat situation even in a dark situation with low lighting.

In addition, according to one embodiment, by applying a weight to the emotion or eye movement of the person in the image, it is possible to determine whether a person in the image is in a threat situation flexibly according to the surrounding situation.

### BRIEF DESCRIPTION OF THE DRAWINGS

FIG. 1 is a block diagram illustrating a facial image analysis-based threat detection apparatus according to one embodiment.

FIG. 2 is a block diagram illustrating the functions of a facial image analysis-based threat detection program.

FIG. 3 is a flowchart illustrating a facial image analysis-based threat detection method according to one embodiment.

FIGS. 4 and 5 are exemplary diagrams specifically showing a process of detecting a threat situation according to the facial image analysis-based threat detection method according to one embodiment.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

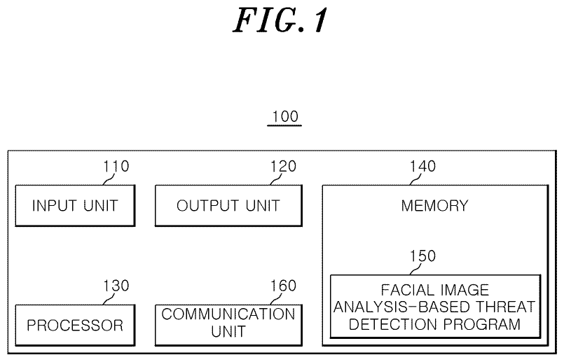

FIG. 1 is a block diagram illustrating a facial image analysis-based threat detection apparatus according to one embodiment.

As shown in FIG. 1, the facial image analysis-based threat detection apparatus 100 may include an input unit 110, an output unit 120, a processor 130, a memory 140, or a communication unit 160.

Hereinafter, for the convenience of explanation, the facial image analysis-based threat detection apparatus 100 is described as including the input unit 110, the output unit 120, the processor 130, the memory 140, or the communication unit 160, as an example, but the present disclosure is not limited thereto. That is, each component may be provided outside the facial image analysis-based threat detection apparatus 100 and may operate in a manner of interacting with the facial image analysis-based threat detection apparatus 100.

The input unit 110 may include a user interface for inputting commands, information, and the like used to control the facial image analysis-based threat detection apparatus 100. Further, the input unit 110 may be a hardware device (e.g., a keyboard, a mouse, a touch pad, etc.) that can directly receive commands, information, and the like used to control the facial image analysis-based threat detection apparatus 100. In addition, in one embodiment, the input unit 110 may be a camera that captures a facial image of a person located at a certain location, so that the facial image analysis-based threat detection apparatus 100 may acquire the facial image through the input unit 110.

The output unit 120 may provide information including an acquired facial image, an inferred emotion, an emotion-based threat score, information related to eye blink frequency, information related to the number of pupil movements, an eye-based threat score, a total threat score, and whether or not a threat has been detected as visual information to a user through an interface.

In one embodiment, the output unit 120 may include a means (e.g., a speaker or a warning light) that can notify the outside world through visual or auditory signals when the person corresponding to the acquired facial image is determined by the processor 130 to be in a threat situation.

The processor 130 may control the overall operation of the facial image analysis-based threat detection apparatus 100 to perform the present disclosure.

The processor 130 may load the facial image analysis-based threat detection program 150 and information necessary for execution of the facial image analysis-based threat detection program 150 from the memory 140 to execute the facial image analysis-based threat detection program 150.

The processor 130 may control the facial image analysis-based threat detection apparatus 100 to store data received from an external device through the communication unit 160 in the memory 140. In addition, the processor 130 may control the facial image analysis-based threat detection apparatus 100 to transmit and receive information including acquired facial images, inferred emotions, emotion-based threat scores, information related to eye blink frequency, information related to the number of pupil movements, eye-based threat scores, total threat scores, and whether or not a threat has been detected to and from the external device through the communication unit 160.

The processor 130 may refer to a processing device such as a microprocessor, a central processing unit (CPU), a graphic processing unit (GPU), a processor core, a multiprocessor, an application-specific integrated circuit (ASIC), a field programmable gate array (FPGA), a micro controller unit (MCU), etc., but is not limited to the above-described examples.

The memory 140 may store the facial image analysis-based threat detection program 150 and information necessary for execution of the facial image analysis-based threat detection program 150 and. In addition, the memory 140 may also store the processing results by the processor 130.

The facial image analysis-based threat detection program 150 may mean software including commands programmed to perform the method according to the present disclosure.

The memory 140 may store information including acquired facial images, inferred emotions, emotion-based threat scores, information related to eye blink frequency, information related to the number of pupil movements, eye-based threat scores, total threat scores, and whether or not a threat has been detected. In addition, the memory 140 may store information received from an external device through the communication unit 160.

The memory 140 may refer to a computer-readable recording medium, such as a magnetic medium (e.g., a hard disk, a floppy disk, and a magnetic tape), an optical medium (e.g., a CD-ROM and a DVD), a magneto-optical medium (e.g., a floptical disk), a random access memory (e.g., a dynamic random access memory (DRAM) or a static random access memory (SRAM)), and a hardware device specifically configured to store and execute program instructions (e.g., a flash memory), but is not limited to the above-described examples.

The communication unit 160 may be a wireless communication module capable of performing wireless communication by adopting a communication method such as CDMA, GSM, W-CDMA, TD-SCDMA, WiBro, LTE, EPC, 5G, wireless LAN, Wi-Fi, Bluetooth, Zigbee, WFD (Wi-Fi Direct), UWB (Ultra Wide Band), infrared communication (infrared data association (IrDA)), BLE (Bluetooth Low Energy), or NFC (near field communication), but is not limited to the above-described examples.

In addition, information input and output through the input unit 110 and the output unit 120, information stored in the memory 140, and information transmitted and received through the communication unit 160 include all information related to the present disclosure, but the present disclosure is not limited thereto.

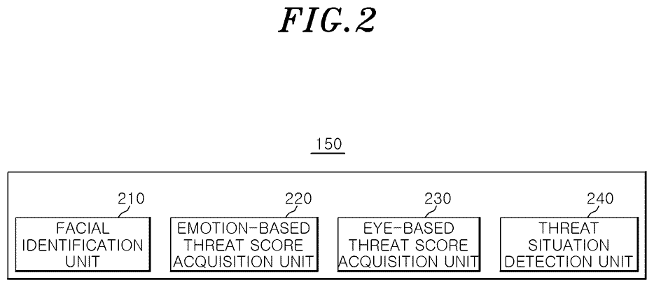

The functions or operations of the facial image analysis-based threat detection program 150 will be described in detail with reference to FIG. 2.

FIG. 2 is a block diagram illustrating the functions of the facial image analysis-based threat detection program 150.

As shown in FIG. 2, the facial image analysis-based threat detection program 150 may include a facial identification unit 210, an emotion-based threat score acquisition unit 220, an eye-based threat score acquisition unit 230, and a threat situation detection unit 240. The facial identification unit 210, the emotion-based threat score acquisition unit 220, the eye-based threat score acquisition unit 230, and the threat situation detection unit 240 are exemplary division of the functions of the facial image analysis-based threat detection program 150, and the present disclosure is not limited thereto.

According to one embodiment, the functions of the face identification unit 210, the emotion-based threat score acquisition unit 220, the eye-based threat score acquisition unit 230, and the threat situation detection unit 240 may be combined or separated, and may be implemented as a series of instructions included in at least one program.

The face identification unit 210, the emotion-based threat score acquisition unit 220, the eye-based threat score acquisition unit 230, and the threat situation detection unit 240 may be implemented by the processor 130, and may refer to a data processing device built in hardware that has a physically structured circuit to perform functions expressed as codes or instructions included in the face image analysis-based threat detection program 150 stored in the memory 140.

The face identification unit 210 can identify a face from a face image acquired from a camera. In one embodiment, the camera may be a near-infrared (NIR) camera, and the face image may be acquired from the near-infrared camera. That is, the face identification unit 210 can effectively acquire a face image even in a dark environment with low illumination.

The emotion-based threat score acquisition unit 220 can infer emotions corresponding to a face. To this end, the emotion-based threat score acquisition unit 220 may include a convolutional neural network (CNN) model for inferring emotions. Specifically, the emotion-based threat score acquisition unit 220 may classify facial expressions and quantify the confidence level for the facial expressions through a CNN-based emotion recognition algorithm. The type of artificial intelligence models used by the emotion-based threat score acquisition unit 220 described above to infer emotions is provided as an example for the convenience of explanation, and the present disclosure is not limited thereto.

The emotion inferred by the emotion-based threat score acquisition unit 220 may include multiple emotion classes. For example, the multiple emotion classes may include emotion classes for joy, sadness, and fear. One or more of these emotion classes, for example, the emotion class for fear, may be associated with threats.

In one embodiment, when it is determined that the inferred emotion belongs to one of preset threat emotion classes, the emotion-based threat score acquisition unit 220 may determine an emotion-based threat score based on the confidence level of the inference. For example, when the inferred emotion is “fear” and the confidence level therefor is 0.95, the emotion-based threat score may be determined as 0.95. For another example, when the inferred emotion is “fear” with a confidence level of 0.9, and a weight for the emotion-based threat score is 0.5, the emotion-based threat score may be determined as 0.45 with the weight applied to the confidence. In this case, the confidence level indicates the accuracy of the inference, meaning a 90% chance that the emotion is fear among several preset emotion classes, with the remaining 10% chance that it is not fear. In addition, the weights may be preset or calculated by considering the confidence levels for the inferred emotion, the eye blink frequency, and the number of pupil movements.

In one embodiment, the emotion-based threat score acquisition unit 220 may determine the emotion-based threat score as 0 if it is determined that the inferred emotion does not belong to any of the preset threat emotion classes, for example, if the inferred emotion is joy. That is, the emotion-based threat score acquisition unit 220 may calculate the emotion-based threat score by not allowing emotion classes other than the preset threat emotion classes to contribute to the emotion-based threat score.

The eye-based threat score acquisition unit 230 can acquire an eye-based threat score based on the eye blink frequency and the number of pupil movements in the face. To this end, the eye-based threat score acquisition unit 230 may include an eye-tracker model for tracking eye movements. Specifically, the eye-based threat score acquisition unit 230 may calculate the eye blink frequency or the number of pupil movements in the face using the eye-tracker model. The eye-based threat score acquisition unit 230 may obtain an eye-based threat score based on the eye blink frequency or the number of pupil movements in the face. Specifically, the eye-based threat score may be obtained based on how high or low the blink frequency of the eyes is relative to a predetermined reference value or based on an increase rate of the eye blink frequency per unit time. For example, the eye-based threat score acquisition unit 230 may assign a score of 0.32 for a 32% increase in blink frequency, and a score of 0.2 for a 20% increase in pupil movement number, and may sum the assigned scores to produce an eye-based threat score of 0.52. Alternatively, each of the eye-based threat scores assigned in this manner may be multiplied by a predetermined weight and then added, rather than simply added. In this case, the weight may be determined depending on the illuminance or fine dust concentration when a facial image is acquired by the camera, or the frequency with which the person usually blinks his or her eyes or the degree to which the person usually moves the pupils, but the present disclosure is not limited thereto.

In one embodiment, the eye-based threat score acquisition unit 230 may obtain an eye-based threat score based on the eye blink frequency, the number of pupil movements, and the confidence levels therefor, which are calculated by quantifying the confidence levels for the eye blink frequency and the number of pupil movements using the eye-tracker model. In this case, the eye-based threat score may be calculated by applying a first confidence level to the eye blink frequency, and applying a second confidence level to the number of pupil movements. For example, the eye-based threat score acquisition unit 230 may assign a score of 0.32 for a 32% increase rate in blink frequency (with a confidence level of 0.5), and a score of 0.2 for a 20% increase rate in pupil movement number (with a confidence level of 0.5), and may calculate an eye-based threat score of 0.26 by adding the scores obtained by applying the confidence level to each assigned score (0.32×0.5+0.2×0.5=0.26). In addition, the weights may be preset or calculated by considering the confidence levels for the inferred emotions, the eye blink frequency, and the number of pupil movements.

In one embodiment, the eye-based threat score acquisition unit 230 can determine the movement of a face to more accurately detect the eye blink frequency or the number of the pupil movements in the face. To this end, the eye-based threat score acquisition unit 230 may more accurately obtain the eye-based threat score by taking into account the movement of the face and correcting errors in eye movement tracking using a head pose estimation algorithm.

The type of model used by the eye-based threat score acquisition unit 230 described above to acquire the eye blink frequency or the number of pupil movements is provided as an example for convenience of explanation, and the present disclosure is not limited thereto.

The threat situation detection unit 240 can detect whether the person corresponding to the face is in a threat situation based on a total threat score calculated by combining the emotion-based threat score and the eye-based threat score. Specifically, the threat situation detection unit 240 may calculate the total threat score by reflecting the result of applying a first weight to the emotion-based threat score and the result of applying a second weight to the eye-based threat score. For example, when the emotion-based threat score is 0.95 with the first weight of 0.4, and the eye-based threat score is 0.52 with the second weight of 0.52, the total threat score can be determined as 0.4×0.95+0.6×0.52=0.692.

In one embodiment, the first weight and the second weight may be determined based on the confidence levels for the inferred emotion, the eye blink frequency, and the number of pupil movements. For example, when the confidence level for the inferred emotion is 0.8, the confidence level for the eye blink frequency is 0.2, and the confidence level for the number of pupil movements is 0.2, the first weight applied to the emotion-based threat score may be determined as 0.8, and the second weight applied to the eye-based threat score may be determined as 0.2 because the confidence level for the inferred emotion is four times greater than the confidence level for the eye blink frequency and the number of pupil movements. However, this is merely an example, and the first weight and the second weight may be determined by combining the confidence levels for the inferred emotion, the eye blink frequency, and the number of pupil movements in different ways.

The threat situation detection unit 240 may determine whether a threat situation exists based on whether the total threat score calculated by combining the emotion-based threat score and the eye-based threat score exceeds a threshold. In this case, the threshold may be preset, but may vary depending on the surrounding environment, such as illumination, the number of people captured by the camera, etc.

In one embodiment, the threat situation detection unit 240 may determine that the person captured in the image is in a state of anxiety or fear based solely on eye movements when the average blink frequency increases by a preset rate or more or the number of pupil movements increases by a preset rate or more. For example, when the average blink frequency increases by 200% or more or the number of pupil movements increases by 300%, the threat situation detection unit 240 may determine that the person captured in the image is in a state of anxiety or fear based solely on eye movements.

In another embodiment, the threat situation detection unit 240 may determine that the person captured in the image is in a state of anxiety or fear based solely on eye movements when an eye movement pattern predefined by a user is detected. For example, when the predefined eye movement pattern is “closing one eye three times within 5 seconds” or “repeating movements to the left, right, up, and down twice,” the threat situation detection unit 240 may determine that the person captured in the image is in a state of anxiety or fear based solely on the eye movements when the predefined eye movement pattern is detected.

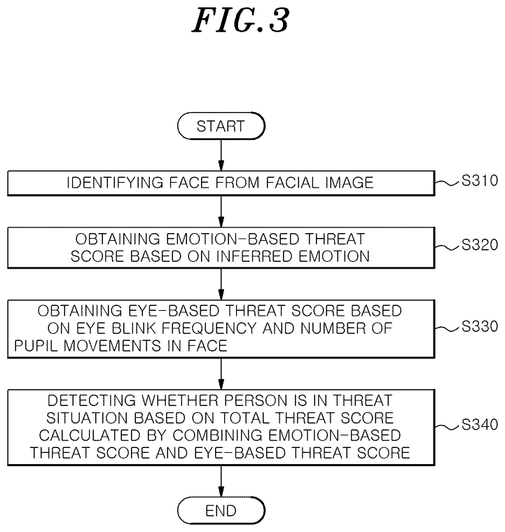

FIG. 3 is a flowchart illustrating a facial image analysis-based threat detection method according to one embodiment. The method illustrated in FIG. 3 can be executed by the facial image analysis-based threat detection apparatus 100 illustrated in FIG. 1. In addition, the flowchart illustrated in FIG. 3 is merely exemplary, and depending on the embodiment, the steps may be executed in a different order from that described in the flowchart, a step not described in the flowchart may be additionally executed, or one or more of the steps described in the flowchart may not be executed.

As shown in FIG. 3, the facial image analysis-based threat detection method according to one embodiment includes: identifying a face from a facial image acquired from a camera (S310), inferring an emotion corresponding to the face and obtaining an emotion-based threat score based on the inferred emotion (S320), obtaining an eye-based threat score based on a blink frequency of the eyes and the number of pupil movements in the face (S330), and detecting whether a person corresponding to the face is in a threat situation based on a total threat score calculated by combining the emotion-based threat score and the eye-based threat score (S340).

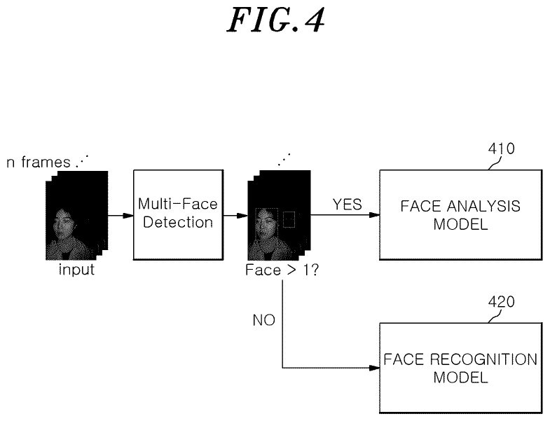

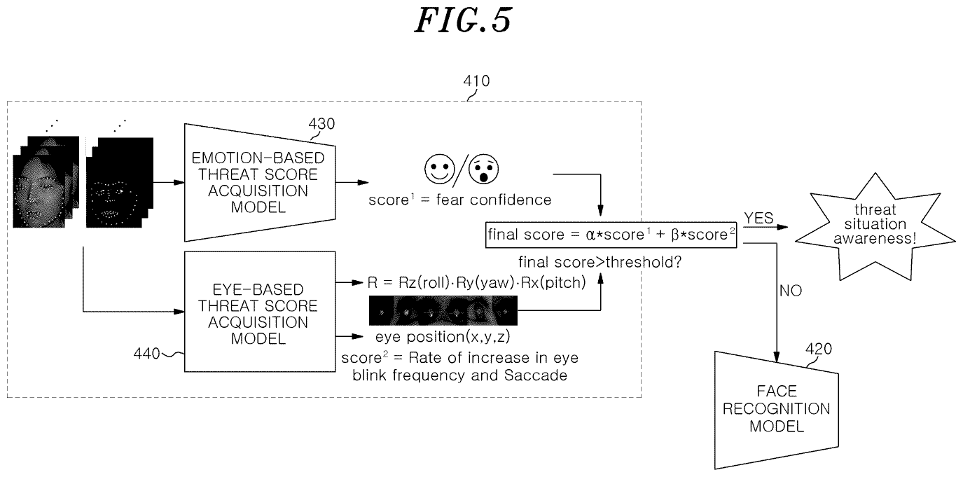

FIGS. 4 and 5 are exemplary diagrams specifically showing a process of detecting a threat situation according to the face image analysis-based threat detection method according to one embodiment.

Referring to FIG. 4, first, a near-infrared (NIR) image may be acquired through the camera. Next, the number of people present in the acquired image may be detected through a multi-face detection algorithm. If the number of people present in the acquired image is 0 or 1, it may not be necessary to analyze whether the person present in the acquired image is in a threat situation. In this case, only the identity of the person present in the acquired image may be identified through a face recognition model 420. In contrast, if the number of people present in the acquired image exceeds 1, whether the person present in the acquired image is in a threat situation may be determined through a face analysis model 410.

In one embodiment, among the individuals present in the acquired image, a person who poses a threat and a person who is threatened may be determined based on emotions, blinking frequency of the eyes in the face, and the number of pupil movements. For example, a person present in the acquired image who has an emotion of fear, whose eyes move quickly and blink frequently may be determined as a person who is threatened.

Referring to FIG. 5, the face analysis model 410 may include an emotion-based threat score acquisition model 430 and an eye-based threat score acquisition model 440. In this case, the emotion-based threat score acquisition model 430 may include a CNN (convolutional neural network) model for inferring emotions. In addition, the eye-based threat score acquisition model 440 may include an eye-tracker model for tracking eye movements or a head pose estimation model for analyzing facial movements.

Images acquired by the camera may be input into both the emotion-based threat score acquisition model 430 and the eye-based threat score acquisition model 440.

The emotion-based threat score acquisition model 430 can infer an emotion corresponding to a face. The emotion-based threat score acquisition model 430 can determine an emotion-based threat score based on the confidence level for the inferred emotion when it is determined that the inferred emotion belongs to one of the preset threat emotion classes. For example, if the inferred emotion is “fear” and the confidence level therefor is 0.95, the emotion-based threat score may be determined as 0.95. In another example, if the inferred emotion is “fear” with a confidence level of 0.9 and a weight for the emotion-based threat score is 0.5, the emotion-based threat score may be determined as 0.45 with the weight applied to the confidence level.

In one embodiment, the emotion-based threat score acquisition model 430 may determine the emotion-based threat score as 0 when it is determined that the inferred emotion does not belong to any of the preset threat emotion classes. In other words, the emotion-based threat score acquisition model 430 may calculate the emotion-based threat score by not allowing emotion classes other than the preset threat emotion classes to contribute to the emotion-based threat score.

The eye-based threat score acquisition model 440 can obtain an eye-based threat score based on the eye blink frequency and the number of pupil movements in the face. The eye-based threat score acquisition model 440 may obtain an eye-based threat score based on the eye blink frequency or the number of pupil movements in the face. For example, the eye-based threat score acquisition model 440 may assign a score of 0.32 for a 32% increase in blink frequency and a score of 0.2 for a 20% increase in pupil movement number, and calculate an eye-based threat score of 0.52 by adding the assigned scores.

In one embodiment, the eye-based threat score acquisition model 440 may obtain an eye-based threat score based on the eye blink frequency, the number of pupil movements, and the confidence levels therefor, which are calculated by quantifying the confidence levels for the eye blink frequency and the number of pupil movements in the face using the eye-tracker model. In this case, the eye-based threat score may be calculated by applying a first confidence level to the eye blink frequency, and applying a second confidence level to the number of pupil movements. For example, the eye-based threat score acquisition model 440 may assign a score of 0.32 for a 32% increase in blink frequency (with a confidence level of 0.5), and a score of 0.2 for a 20% increase in pupil movement number (with a confidence level of 0.5), and calculate an eye-based threat score of 0.26 by adding the scores obtained by applying the confidence level to each assigned score (0.32×0.5+0.2×0.5=0.26).

In one embodiment, the eye-based threat score acquisition model 440 can determine the movement of the face to more accurately detect the eye blink frequency or the number of movements of the pupil in the face. To this end, the eye-based threat score acquisition model 440 can more accurately acquire the eye-based threat score by taking into account the movement of the face and correcting errors in eye movement tracking using the head pose estimation algorithm. Specifically, when head movement occurs, the eye-based threat score acquisition model 440 may obtain yaw, pitch, and roll values for the head movement through the head pose estimation algorithm, and obtain a 3×3 rotation matrix R using these values as shown in Equation 1.

$$R = {R}_{z} ( α ) {R}_{y} ( β ) {R}_{x} ( γ ) = [ \begin{matrix}cos α & - sin α & 0 \\ sin α & cos α & 0 \\ 0 & 0 & 1\end{matrix} ] [ \begin{matrix}cos β & 0 & sin β \\ 0 & 1 & 0 \\ - sin β & 0 & cos β\end{matrix} ] [ \begin{matrix}1 & 0 & 0 \\ 0 & cos γ & - sin γ \\ 0 & sin γ & cos γ\end{matrix} ] \qquad ( Equation 1 )$$

By multiplying eye coordinates (x, y, z) in the previous frame t−1 calculated through the eye-tracker model and the rotation matrix R calculated through the head pose estimation of the current frame t, the gaze vector (calibrated eye coordinates) (x_{c}, y_{c}, z_{c}) in the current frame can be predicted.

Next, the pupil coordinates can be redefined by calculating the error |(x_{c}, y_{c}, z_{c})−(x, y, z)| between the gaze vector (calibrated eye coordinates) (x_{c}, y_{c}, z_{c}) and the eye coordinates (x, y, z) in the current frame, as shown in Equation 2.

$$Calibrated eye coordinate ( xc , yc , zc ) = R * eye coordinate ( x , y , z ) \qquad ( Equation 2 )$$

$$eye coordinate error ( xdiff , ydiff , zdiff ) = \vert calibrated eye coordinate ( xc , yc , zc ) - eye coordinate ( x , y , z ) \vert$$

A total threat score can be calculated by combining the emotion-based threat score and the eye-based threat score. Based on the calculated total threat score, it is possible to detect whether the person corresponding to the face is in a threat situation. Specifically, the total threat score can be calculated by reflecting the result of applying the first weight to the emotion-based threat score and the result of applying the second weight to the eye-based threat score. For example, when the emotion-based threat score is 0.95 with a weight of 0.4, and the eye-based threat score is 0.52 with a weight of 0.6, the total threat score can be determined as 0.692 (0.4×0.95+0.6×0.52=0.692).

If the total threat score exceeds a threshold, the apparatus detects a threat situation and can issue an alert externally. If the total threat score does not exceed the threshold, face recognition for a person in the camera image may be performed through the face recognition model 420.

As described above, according to one embodiment of the present disclosure, it is possible to determine whether a person in the image is in a threat situation based on the emotion or eye movement of the person in the image.

Further, it is possible to be accurately determine whether a person in the image is in a threat situation even in a dark environment with low illuminance.

In addition, according to one embodiment, by applying weights to the emotions or eye movements of the person in the image, it is possible to determine whether the person in the image is in a threat situation flexibly according to the surrounding circumstances.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed is:

1. A method for threat detection based on facial image analysis performed by a facial image analysis-based threat detection apparatus, the method comprising:
identifying a face from a facial image acquired from a camera;
inferring an emotion corresponding to the face to obtain an emotion-based threat score based on the inferred emotion;
obtaining an eye-based threat score based on a blink frequency of eyes on the face and a number of pupil movements in the face; and
detecting whether a person corresponding to the face is in a threat situation based on a total threat score calculated by combining the emotion-based threat score and the eye-based threat score.

2. The method of claim 1, wherein the camera is a near-infrared (NIR) camera, and the facial image is acquired from the near-infrared camera.

3. The method of claim 1, wherein when the inferred emotion belongs to one of preset threat emotion classes, the emotion-based threat score is determined dependent on a confidence level for the inferred emotion.

4. The method of claim 1, wherein when the inferred emotion does not belong to any of preset threat emotion classes, the emotion-based threat score is determined to be 0.

5. The method of claim 1, wherein the eye-based threat score is calculated by applying a first confidence level to the eye blink frequency and a second confidence level to the number of pupil movements.

6. The method of claim 1, further comprising acquiring movement of the face,
wherein the eye-based threat score is calculated by identifying the movement of pupil in the face while taking the movement of the face into account.

7. The method of claim 1, wherein the total threat score is calculated by reflecting a result of applying a first weight to the emotion-based threat score and a result of applying a second weight to the eye-based threat score.

8. The method of claim 7, wherein the first weight and the second weight are determined based on confidence levels for the inferred emotion, the eye blink frequency, and the number of pupil movements.

9. The method of claim 1, wherein in the detecting whether a person corresponding to the face is in a threat situation, it is determined that the person is in the threat situation when the total threat score exceeds a threshold.

10. An apparatus for threat detection based on facial image analysis comprising:
a memory storing computer-executable instructions; and
a processor configured to execute the instructions to:
identify a face from a facial image acquired from a camera;
infer an emotion corresponding to the face to obtain an emotion-based threat score based on the inferred emotion;
obtain an eye-based threat score based on a blink frequency of eyes on the face and a number of pupil movements in the face; and
detect whether a person corresponding to the face is in a threat situation based on a total threat score calculated by combining the emotion-based threat score and the eye-based threat score.

11. The apparatus of claim 10, wherein the camera is a near-infrared (NIR) camera, and the facial image is acquired from the near-infrared camera.

12. The apparatus of claim 10, wherein when the inferred emotion belongs to one of preset threat emotion classes, the emotion-based threat score is determined dependent on a confidence level for the inferred emotion.

13. The apparatus of claim 10, wherein when the inferred emotion does not belong to any of preset threat emotion classes, the emotion-based threat score is determined to be 0.

14. The apparatus of claim 10, wherein the eye-based threat score is calculated by applying a first confidence level to the eye blink frequency and a second confidence level to the number of pupil movements.

15. The apparatus of claim 10, wherein the processor acquires movement of the face, and wherein the eye-based threat score is calculated by identifying the movement of pupil in the face while taking the movement of the face into account.

16. The apparatus of claim 10, wherein the total threat score is calculated by reflecting a result of applying a first weight to the emotion-based threat score and a result of applying a second weight to the eye-based threat score.

17. The apparatus of claim 16, wherein the first weight and the second weight are determined based on confidence levels for the inferred emotion, the eye blink frequency, and the number of pupil movements.

18. The apparatus of claim 10, wherein the processor determines that the person is in the threat situation when the total threat score exceeds a threshold.

19. A non-transitory computer-readable storage medium storing computer-executable instructions, wherein the computer-executable instructions, when executed by a processor, cause the processor to perform a method including:
identifying a face from a facial image acquired from a camera;
inferring an emotion corresponding to the face to obtain an emotion-based threat score based on the inferred emotion;
obtaining an eye-based threat score based on a blink frequency of eyes on the face and a number of pupil movements in the face; and
detecting whether a person corresponding to the face is in a threat situation based on a total threat score calculated by combining the emotion-based threat score and the eye-based threat score.
